(19) United States
(12) Patent Application Publication
(10) Pub. No.: US 2010/0082537 A1
(43) Pub. Date: Apr. 1, 2010

(54) FILE SYSTEM FOR STORAGE DEVICE WHICH USES DIFFERENT CLUSTER SIZES

(76) Inventor: Menahem Lasser, Kohav-Yair (IL)

Correspondence Address: VIERRA MAGEN/SANDISK CORPORATION, 575 MARKET STREET, SUITE 2500, SAN FRANCISCO, CA, 94105, US

(21) Appl. No.: 12/568,962

(22) Filed: Sep. 29, 2009

Related U.S. Application Data
(60) Provisional application No. 61/100,851, filed on Sep. 29, 2008.

(51) Int. Cl. G06F 12/02; G06F 12/00; G06F 13/28; G06F 13/00

(52) U.S. Cl. 707/610; 711/103; 707/E17.01; 711/E12.001; 711/E12.008

(57) ABSTRACT

A file system for managing files in a storage device in a more optimal way by providing allocation units or clusters with non-uniform sizes. Clusters of at least two different sizes are allocated in a common partition of a storage device, such as a hard disk drive, other magnetic media, optical media and semiconductor storage such as flash memory and other non-volatile memory. At least two clusters are allocated in the storage device for storing the files. First and second allocated clusters are allocated to first and second portions of the storage device, respectively, and contain different numbers of sectors. One or more optimum cluster sizes can be selected for storing the files without knowing the size of the files in advance, based on factors such as whether compression is to be performed, file type, access patterns of a calling application, and an identification of the calling application.

### CROSS-REFERENCE TO RELATED APPLICATIONS

This application claims the benefit of U.S. provisional patent application No. 61/100,851, filed Sep. 29, 2009, and incorporated herein by reference.

### BACKGROUND

The present technology relates to a file system for a storage device.

Many file systems (like File Allocation Table (FAT) and MICROSOFT WINDOWS NT® FILE SYSTEM (NTFS)) allocate storage for their files in units that may be larger than the basic units of data exchanged between the host and the file system. For example, NTFS typically works with sectors (the units exchanged with the host) that are 512 bytes. But when allocating space on the storage media, NTFS may use as a basic size much larger data chunks (called “clusters” or “allocation units”). For NTFS, the range of cluster sizes supported is between 1 sector to 128 sectors per cluster (that is—between 0.5 KB and 64 KB), with 8 sectors (4 KB) being the most common size.

Such file systems can be used for storing data in various storage media, including disk storage such as a hard disk drive, other magnetic media, optical media and semiconductor storage such as flash memory and other non-volatile memory, e.g., in a solid state drive. Such storage media are storage devices which are commonly used in various electronic devices such as cellular telephones, digital cameras, personal digital assistants, mobile computing devices, non-mobile computing devices, laptop or desktop computers, servers, and other devices.

However, there are conflicting considerations regarding what cluster size to use (e.g., large or small).

U.S. Pat. No. 5,832,525 provides a File Allocation Table (FAT) file system which uses two or more FAT file systems with different cluster sizes to form a single user-visible FAT file system to reduce disk fragmentation. The smaller clusters are hidden inside larger clusters and thus not exposed to the user. However, the use of multiple file systems introduces additional complexity.

Japanese Publication No. JP2000-357112 provides a file system driver which can use multiple cluster sizes for the same partition of a hard disk. The file system driver compares the size of a file with the available cluster sizes to make a decision about which clusters to use to store the file. However, this approach relies on knowing the file size in advance, when the decision is made, which is typically when the file is created. In practice, a file system does not know the file size when creating a file, so this approach is of limited utility.

### BRIEF DESCRIPTION OF THE DRAWINGS

FIG. 1 depicts a system in which a host controller communicates with a storage system to write and read data.

FIG. 2 depicts a file which has multiple sectors of data.

FIG. 3 depicts an address space of a storage device with non-uniformly sized clusters.

FIG. 4 depicts clusters of varying sizes from the address space of FIG. 3.

FIG. 5 depicts a file directory and a file allocation table of a file system for use with the address space of FIG. 4.

FIG. 6 depicts a correspondence between cluster numbers and sector addresses.

FIG. 7 depicts a cluster size selection process.

FIG. 8 depicts a process for writing data.

### DETAILED DESCRIPTION

The present technology relates to a file system for a storage device. As mentioned at the outset, there are conflicting considerations regarding what cluster size to use (e.g., large or small) in a storage system.

The larger the cluster, the more space is wasted in the media. As the cluster is the smallest allocation unit, if a file is smaller than a cluster, it still gets a full cluster allocated to it. If the cluster size is 8 sectors and a file requires only one sector, the last 7 sectors in the allocated cluster are wasted. This type of waste occurs not only in small files—even in large files, if their size is not evenly dividable into the cluster size, the last cluster assigned will be partially wasted. If the cluster size is much bigger than the sector size, one may use the approximation that each file wastes half a cluster on average. As a result, from this consideration it should be preferable to use small clusters.

The smaller the cluster size, the more space is required for managing the storage device. For a fixed size of the storage device, the number of clusters gets higher as the cluster size goes down. Therefore, as the cluster size goes down, larger tables are required for management and control of the file system (see the FAT allocation tables as an example). We may also look at it from the other side—for a fixed size of management tables, the smaller the cluster size the smaller is the maximal storage device size that can be supported. As a result, from this consideration it should be preferable to use large clusters.

Consideration of files compression supports using smaller clusters. If a host requests to read a single sector out of a cluster, in most compression schemes it is required to decompress the full cluster. If the cluster is much larger than the sector, this results in highly inefficient operation. Actually, newer versions of NTFS, 3.51 and above, do not format storage devices with clusters bigger than 4 KB because they support file compression.

For flash memory storage devices (or other technologies in which updating data cannot be done by over-writing it in place, requiring complex management algorithms) optimal cluster size for best performance may be affected by the average host write operations size. The interaction depends on the specific algorithms of the file system and the underlying flash management driver and physical characteristics of the flash media. As an example, if the flash page size is smaller than the cluster size and the host is writing data in small chunks, the amount of fragmentation increases, causing performance to decrease.

As we see from the above, the considerations for selecting cluster size are complex. Some of them might not even be the same for all files—some files may need compression while others do not, some files are typically written in small chunks while other in large chunks. File systems which employ a fixed cluster size for a storage device are not optimal for each case and each file. It is desired to provide better cluster size selection. When a fixed cluster size is applied to each storage device, the cluster size is typically selected according to the storage device capacity—the larger the storage device, the bigger the cluster size.

When the storage device is divided into multiple partitions, each partition gets its own cluster size, not necessarily the same size for all partitions. The drawback of this method is that the host/user sees each partition as a separate disk storage device. Therefore, the decision about which cluster size a file gets must be made by the calling application rather than by the file system. This requires the calling application to have additional intelligence and knowledge about internal workings of the storage device and the file system.

The present technology proposes to have a file system supporting multiple values of cluster sizes within the same storage device and partition. For example, the first part of the storage device (in terms of logical addresses in the address space) may use a cluster size of 2 KB, and the rest of the storage device may use a cluster size of 8 KB. The file system will store files in the part most suitable for them—files for which the host requested compression will be directed to the first (small cluster) part, while files not to be compressed will be directed to the second (large cluster part). Files that the file system will determine to be typically written in large chunks (for example according to file type as determined by name extension, or by the calling applications providing that indication, or by monitoring their access patterns during operation) will be written to the large clusters area, while other files will be written to the small clusters area. Small files may be written to the small clusters area, reducing the percentage of space wasted.

In order to gain the advantages of the present technology, an existing file system can be modified to support different cluster sizes in the same partition. This can be achieved, for example, in a FAT file system by changing the procedures for converting from sector number to cluster number and vice-versa. With a small number of different cluster sizes and known borders between the portions in the address space, such conversions are straightforward. Once this is done, the file system may be modified to take advantage of the multiple cluster sizes as explained herein.

The multiple cluster sizes and the division of the address space between them will typically be determined at formatting time. The information will be kept in management sectors at the beginning of the storage device, much as today's single cluster size is kept there. This allows any host carrying a file system modified accordingly to read to, and write from, the storage device. Changing cluster size configurations during run-time according to a host command is also feasible, although it adds complexity.

The file system may also be internal to the storage system (as in the Media Transfer Protocol (MTP)). MTP supports the transfer of music files on digital audio players and movie files on portable media players. MTP is part of the MICROSOFT WINDOWS MEDIA framework and related to WINDOWS MEDIA PLAYERS.

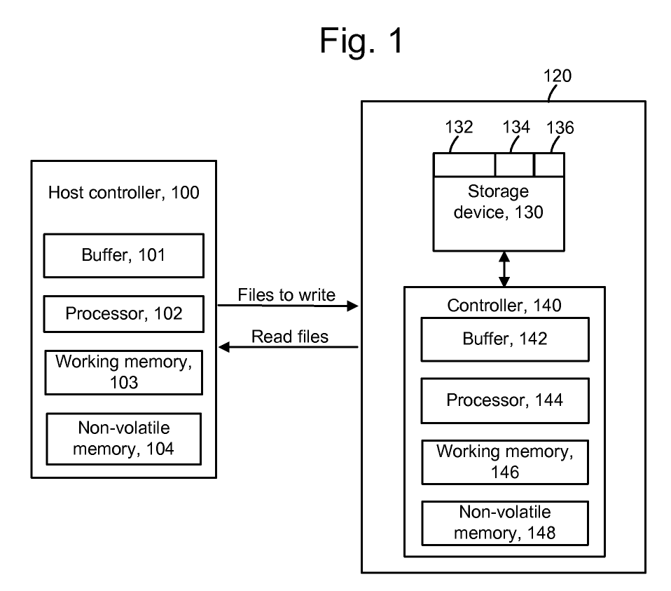

FIG. 1 depicts a system in which a host controller 100 communicates with a storage system 120 to write and read data. The file system technique provided herein is applicable to essentially any type of storage system, including disk storage such as a hard disk drive, other magnetic media, optical media and semiconductor storage such as flash. In one possible approach, the storage system may include a storage device formed on a removable memory card or USB flash drive, for instance. The storage system is inserted into a host device such as a laptop computer, digital camera, personal digital assistant (PDA), digital audio player or mobile phone.

The host controller 100 includes a buffer 101, processor 102, working memory 103 and a non-volatile memory. The storage system 120 includes a storage device 130 and a controller 140. The storage device 130 includes example portions 132, 134 and 136, discussed further below. The controller 140 includes a buffer 142, a processor 144, a working memory 146 and a non-volatile memory 148.

The non-volatile memory 104 and/or 148 may be considered to be a processor readable storage device having processor readable code embodied thereon for programming one or more processors, such as the processor 102 and/or 144, to enable the host controller 100 to perform computer-implemented methods for reading and writing data.

Similarly, the non-volatile memory 148 may be considered to be a processor readable storage device having processor readable code embodied thereon for programming one or more processors, such as the processor 144, to enable the controller 140 to perform computer-implemented methods for reading and writing data. In particular, the code at the non-volatile memory 104 may implement a file system which manages the writing and reading of files at the storage device 130. The code for the file system typically runs at the host controller side, such as the personal computer (PC) side, although it can run elsewhere. An exception is the MTP case mentioned above. The code in the storage controller 140 typically only performs simple commands received from the host, such as “write/read a sector,” “write/read a sequence of sectors,” and so forth, without really knowing to which file each sector belongs, or even not knowing whether a sector is part of a file or a part of a management table such as an allocation table. The code is used by the processor 102 to allocate clusters to files and their sectors. A sector is a logical concept used by the host as a convenient unit of user data; it typically does not contain overhead data, which is confined to the controller 140. A sector of user data is typically 512 bytes, corresponding to the size of a sector in magnetic disk drives although, as mentioned, a storage device can include any storage medium and not just magnetic disk drives.

The host controller 100 interacts with the storage system 120, such as to read or write one or more files of user data, by providing a read or write command, respectively. In one possible approach, the storage system 120, under the direction of the processor 144, stores write data temporarily in the buffer 142 before writing it to the storage device 130, and informs the host controller 100 of when new write data can be received. Similarly, the storage system 120, under the direction of the processor 144, may respond to a read command by reading data from the storage device 130, storing it in the buffer 142 and informing the host controller 100 when the data is ready to be read from the buffer 142.

The storage system and host controller can communicate with one another via a local or remote network connection. Alternatively, the storage system may be physically attached to the host controller, as is the case, for example, when a memory card is physically inserted into a slot in a camera, or when a disk drive is installed into a PC. The use of a separate storage system and host controller is an example only as many other configurations for implementing a file system as described herein are possible. For example, a unitary device may implement a file system to read and write data internally.

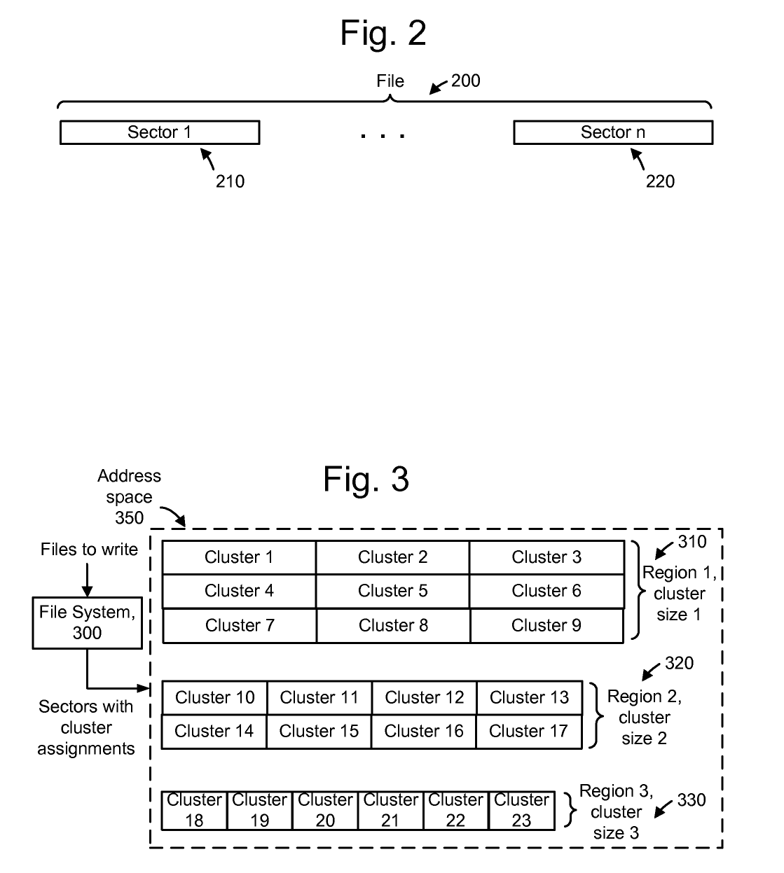

FIG. 2 depicts a file 200 which has multiple sectors of data, such as a first sector 1 (210), a last or nth sector (220), and n−2 intermediate sectors. As mentioned, a file may have several sectors of data. Typically, the total number (n) of sectors of data in a file is not known ahead of time when the data is being written to memory.

FIG. 3 depicts an address space of a storage device with non-uniformly sized clusters. The address space 350 may apply to any type of storage media, as mentioned, and represents a common partition of the storage device. Generally, a storage device can have one or more partitions. A file system 300 maintains a record of which clusters are associated with which files. The clusters can be chosen to be any size. Further, it is not required for the smaller clusters to be an integral fraction (e.g., ½, ⅓, ¼, ⅛, etc.) of a larger cluster, although this is possible. The clusters of different sizes are thus exposed and not hidden inside larger clusters. By providing clusters of different sizes, the storage space can be more efficiently used. For example, fragmentation can be decreased.

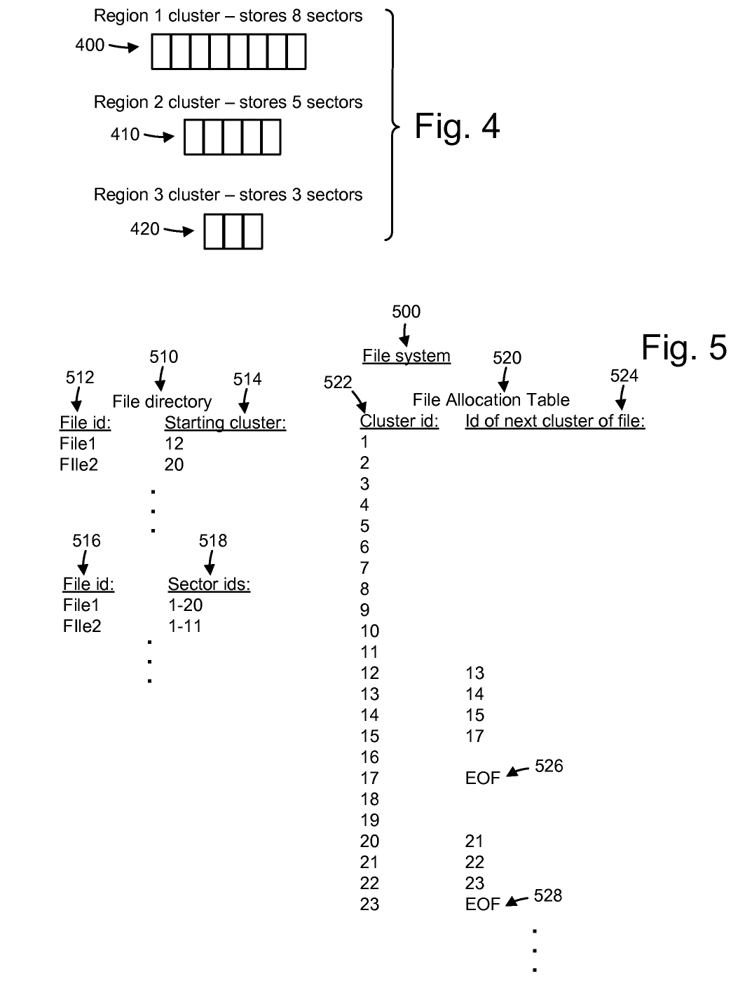

In one possible approach, the logical address space is divided into a number of regions, e.g., two or more regions, where each region represents a range of clusters which have a common cluster size, and different regions use different cluster sizes. For example, a region 1 (310) spans clusters 1-9, each with size 1, a region 2 (320) spans clusters 10-17, each with size 2, and a region 3 (330) spans clusters 18-23, each with size 3. Moreover, each region may correspond to a different portion of the storage device. For example, regions 310, 320 and 330 may correspond to portions 132, 134 and 136, respectively. In an example implementation, size 1 is 8 sectors, size 2 is 5 sectors and size 3 is 3 sectors, as depicted in FIG. 4. FIG. 4 depicts clusters of varying sizes from the address space of FIG. 3, including a cluster 400 which stores 8 sectors, a cluster 410 which stores 5 sectors, and a cluster 420 which stores 3 sectors. Moreover, the number of sectors in each region can differ. For example, region 1 (310) may include 9 clusters, each storing 8 sectors, for a total of 72 sectors. Region 2 (320) may include 8 clusters, each storing 5 sectors, for a total of 40 sectors. Region 3 (330) may include 6 clusters, each storing 3 sectors, for a total of 18 sectors. It is also possible to mix the cluster sizes so that they are not grouped contiguously in regions. For example, a group of clusters which each store 8 sectors can be separated by a group of clusters which each store 5 sectors. It is also possible for a file to be written to clusters of different sizes. For example, a file can be written to sectors in different regions. For instance, a file of 12 sectors can be written so that 8 sectors are written to region 1 (310) and 4 sectors are written to region 2 (320).

The different cluster sizes can be exposed outside the storage system, and smaller clusters are not hidden inside larger clusters. The clusters can be directly addressed without reference to other clusters.

FIG. 5 depicts a file directory 510 and a file allocation table (FAT) 520 of a file system 500 for use with the address space of FIG. 4. The file directory 510 and the file allocation table (FAT) 520 can be maintained by the processor 102, for instance. The file directory 510 includes a file identifier (id) 512 such as a file name, and an identifier of a starting cluster 514 which contains an initial sector of a file. In this simplified example, the files include a first file, File1, which has a starting cluster of 12, and a second file, File2, which has a starting cluster of 20. Additionally, a record can be maintained of the number of sectors of a file using a file identifier 516 and an identifier of the number or range of sectors 518. For example, File1 has sectors 1-20 and File2 has sectors 1-11.

The FAT was originally created for managing disks in the disk operating system (DOS). The FAT centralizes information about which areas of the storage media belong to files, are free or possibly unusable, and where each file is stored on the storage media. The FAT is a one column table, indexed by the cluster number using a cluster identifier (id) 522, and providing, in a field 524, the next cluster of the file, an end of file (EOF) marker (526 and 528), a bad cluster marker or a “not used” marker. The FAT allows different clusters which store data from the same file to be linked or chained to one another. The presence of a next cluster identifier or EOF code indicates that a cluster is in use.

Accessing the entire length of a file is achieved using a combination of the file's directory entry and its cluster entries in the FAT. For example, the starting cluster of File1 is cluster 12, from the file directory, and, from the FAT, the next cluster of File1 is cluster 13, after which the next cluster of File1 is cluster 14, after which the next cluster of File1 is cluster 15, after which the next cluster of File1 is cluster 17. Cluster 17 is also the last cluster of File1 due to the EOF indication 526. Further, the starting cluster of File2 is cluster 20, from the file directory, and, from the FAT, the next cluster of File2 is cluster 21, after which the next cluster of File2 is cluster 22, after which the next cluster of File2 is cluster 23, which is also the last cluster due to the EOF indication 528. The file directory and FAT thus allow a given file or sector to be immediately located in one or more particular clusters.

In the above example, for File1, the 20 sectors are stored in four clusters (of length 5 sectors each), so each cluster is fully utilized. For File2, the 11 sectors are stored in four clusters, where the first 3 clusters (of length 3 sectors each) are fully utilized and the fourth cluster is ⅔ utilized, with one sector unused. A high utilization rate can thus be achieved.

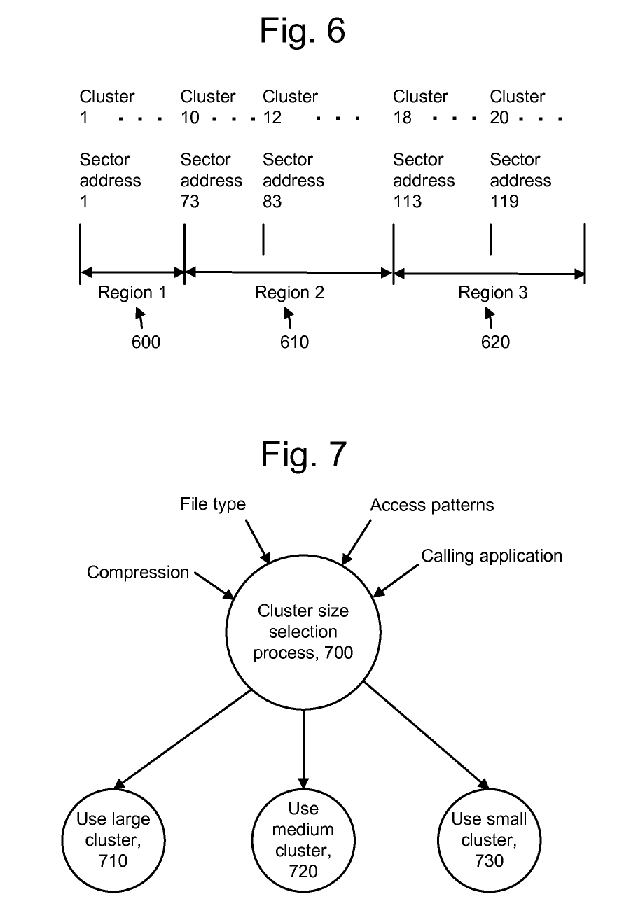

FIG. 6 depicts a correspondence between cluster numbers and sector addresses. In the above example, region 1 (600) includes nine clusters, each having a width of eight sectors. We can define a sector address of 1 for the first sector of cluster 1, which is also the first sector of region 1, a sector address of 73 for the first sector of cluster 10, which is also the first sector of region 2 (610), and a sector address of 113 for the first sector of cluster 18, which is also the first sector of region 3 (620). The sector address is the same as a number of the sector in this example.

A sector address can be converted to a cluster number, and a cluster number can be converted to a sector number. To achieve this, in the case of contiguous address ranges within a region having a uniform cluster size, we need only keep in the storage device the various cluster sizes and the border addresses where the sizes change. In the example of FIG. 3, the border addresses are sector address 1 at the start of region 1, sector address 73 at the start of region 2, and sector address 113 at the start of region 3. The sector sizes are 8, 5 and 3 sectors in regions 1, 2 and 3, respectively.

For instance, with the starting cluster of 12 for File1, the sector number can be determined by determining which region cluster 12 is in. Since there are (73-1)/8=9 clusters in region 1, and there are (113-73)/5=40/5=8 clusters in region 2, cluster 17 is the last cluster in region 2. Further, 9<12<17, and 12−9=3, so cluster 12 is the third cluster in region 2. With the sector address of 73 at the start of cluster 10, and 5 sectors per cluster, and cluster 12 being two clusters away from cluster 10, the starting sector of cluster 12 is: 73+(2×5)=83.

Similarly, for the starting cluster of 20 for File2, the sector number is determined by determining which region cluster 20 is in. Since cluster 17 is the last cluster in region 2, and 20>17, and 20−17=3, we conclude that cluster 20 is the third cluster of region 3. With the sector address of 113 at the start of cluster 18, and 3 sectors per cluster, and cluster 20 being two clusters away from cluster 18, the starting sector of cluster 20 is: 113+(2×3)=119.

To convert from sector number to cluster number, consider sector 83. We determine that sector 83 is between the boundary sectors 73 and 113, so it is in region 2. With 5 sectors per cluster in region 2, and (83−73)/5=2, we conclude that sector 83 is 2 clusters away from the first cluster in region 2, or 3 clusters away from the last cluster in region 1. With (73−1)/8=9 clusters in region 1, we conclude that sector 83 is in cluster 12 (since 9+3=12).

To convert from sector number to cluster number with sector 119, we determine that sector 119 is above the boundary sector 113, so it is in region 3. With 3 sectors per cluster in region 3, and (119−113)/3=2, we conclude that sector 119 is 2 clusters away from the first cluster in region 3, or 3 clusters away from the last cluster in region 2. With (73−1)/8=9 clusters in region 1, and (113−73)/5=8 clusters in region 2, we conclude that sector 119 is in cluster 20 (since 9+8+3=20).

The above results can be obtained by executing appropriate instructions in a processor to convert between cluster number and sector address, and vice-versa.

FIG. 7 depicts a cluster size selection process 700. Decision nodes 710, 720 and 730 indicate that large, medium or small clusters, respectively, should be used. As indicated, a cluster size selection process can be carried out by the file system, without knowing in advance the size of the file which is to be written. When the size of the file is known before the file is written, it is straightforward to select optimal cluster sizes. However, typically the writing of a file begins without knowing the total file size. Accordingly, an intelligent selection process is needed to select an optimal cluster size.

Various criteria can be considered in allocating one or more clusters to a file. For example, files which are to undergo compression before being written can be directed to a smaller cluster, while files which are not to undergo compression before being written can be directed to a larger cluster. Files that the file system determines to be typically written in large chunks (for example according to file type as determined by name extension, or by the calling application's identity, or by monitoring their access patterns during operation) can be written to the larger clusters, while other files can be written to the smaller clusters.

Regarding compression, data compression creates a compressed version of a file by minimizing redundant data. For example, the NTFS file system volumes support file compression on an individual file basis. Lossless compression can be used. Examples of lossless compression algorithms include Lempel-Ziv compression, Huffman encoding and run-length encoding. For one or more files to be written, a processor 102 such as in the host 100 (or the processor in the storage system 120) (FIG. 1), can decide whether to perform compression before writing one or more files to the storage device. This decision can then be factored into the decision of choosing a cluster size to store data, from among two or more available cluster sizes in a common partition of a storage device. For example, one or more files which are to be compressed can be written to one or more smaller clusters, and one or more files which are not to be compressed can be written to one or more larger clusters. An instruction regarding compression could also be provided by another entity, such as the calling application.

Regarding the use of a file type as determined by name extension, a filename extension is typically a suffix to the name of a computer file applied to indicate the encoding convention (file format) of its contents. Examples include .TXT, .HTML, .DOC, and .XLS. Filename extensions can be considered a type of metadata. For instance, text data such as in a .TXT file may typically contains less data than image data such as in a .JPEG file. The file system can therefore be configured to write a .TXT file to a smaller cluster, and to write a .JPEG file to a larger cluster.

In another example, a multimedia (audio and video) file type such as .AVI, 0.3GP, .MOV, or .MP4 may typically contain relatively more data and be stored in one or more larger clusters, while an audio file type such as .WMA or .MP3 may typically contain relatively less data and be stored in one or more medium clusters, and a spreadsheet application such as a MICROSOFT EXCEL® file type of .XLS may typically contain relatively even less data and be stored in one or more smaller clusters.

The calling application, which calls the file system, can be recognized based on an identifier or other information. For instance, a data packet provided by an application can include an identifier of the application in a header of the packet. Alternatively, many Operating Systems provide means for the called file system to determine the identity of the calling application without requiring the calling application to specifically provide any data packet or explicit identifier. The calling application may be correlated to the file type. For example, a word processing application may typically generate .DOC files, while a spreadsheet application generates .XLS files. In another example, an application which updates a calendar function of a cell phone, or which stores e-mail messages, may generate larger files than an application which stores audio and video files. Files from calling applications which are associated with smaller file sizes can be written to one or more smaller clusters, and files from calling applications which are associated with larger file sizes can be written to one or more larger clusters.

Regarding monitoring the access pattern of a calling application, the access pattern of an application can be obtained by, for example, using file system code to track the sizes of data chunks written by an application over some time interval. When the application creates a new file, a cluster size can be selected for this file that is close to the typical, e.g., average or median, data chunk size. Another example is tracking the sizes of data chunks which are read by the application, and selecting cluster size for a new file that matches or otherwise corresponds to the typical data chunk which is read. For example, assume three data chunks of an application which are written have sizes of 8 KB, 10 KB, and 15 KB. Then, an appropriate cluster size for a new file to be written from this application might be the average value of 12 KB or the median of 10 KB. Of the available cluster sizes, the size which is closest to this value might be selected, for instance.

Note that it is possible to select one or more different cluster sizes for writing one or more files. Thus, clusters which are all of one size may be selected for writing one or more files, or one or more clusters of a first size, and one or more clusters of a second size may be selected, and so forth. For example, assume a first cluster size of 1 KB and a second cluster size of 5 KB. If the expected file size is 12 KB, then two 5 KB clusters and two 1 KB clusters can be selected.

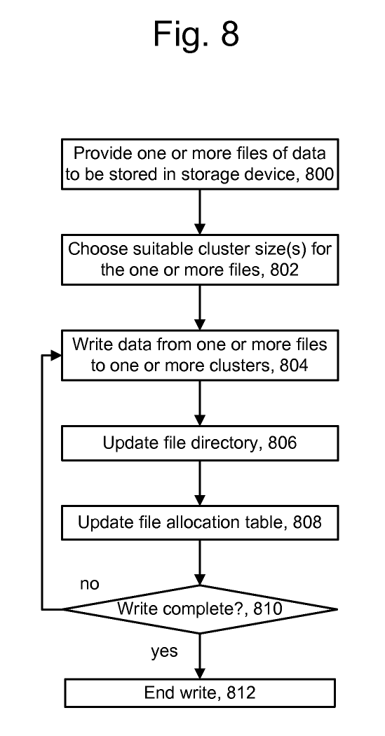

FIG. 8 depicts a process for writing data. Step 800 includes providing one or more files of data to be stored in a storage device. For example, the files may be provided by an external host to a storage system. Step 802 includes choosing one or more suitable cluster sizes for the one or more files, from two or more available cluster sizes. As mentioned, this can be advantageously done without knowing the file size based on one or more selection criteria. Step 804 includes writing data from the one or more files to one or more clusters, based on the one or more selected cluster sizes. Step 806 includes updating a file directory, such as with one or more starting clusters and sector identifiers. Step 808 includes updating a file allocation table, such as for chaining clusters. At decision step 810, if the write operation is complete, the operation ends at step 812. If the write process is not complete, the process continues at step 804.

Accordingly, it can be seen that, in one embodiment, a storage apparatus is provided which includes a storage device, and one or more processors executing code to manage the storage device. The one or more processors generate data to be stored in one or more files in the storage device, where each file comprises a plurality of sectors of data. The one or more processors, without knowing a size of the one or more files, allocate at least two clusters in the storage device for storing the one or more files, wherein the at least two clusters are in a common partition of the storage device, and wherein a first one of the allocated clusters is allocated to a first portion of the storage device and contains a first number of sectors, a second one of the allocated clusters is allocated to a different, second portion of the storage device and contains a second number of sectors, and the first and second numbers of sectors are different from each other. Further, the one or more processors store the one or more files in the allocated clusters.

In another embodiment, a computer-implemented method for writing data to a storage device is provided. The method generates data to be stored in one or more files in the storage device, where each file comprises a plurality of sectors of data. The method further includes without knowing a size of the one or more files, allocating at least two clusters in the storage device for storing the one or more files, wherein the at least two clusters are in a common partition of the storage device, and wherein a first one of the allocated clusters is allocated to a first portion of the storage device and contains a first number of sectors, a second one of the allocated clusters is allocated to a different, second portion of the storage device and contains a second number of sectors, and the first and second numbers of sectors are different from each other. The method further includes storing the one or more files in the allocated clusters

Corresponding computer-implemented methods, systems and computer- or processor-readable storage devices which are encoded with instructions which, when executed, perform the methods provided herein, may be provided.

The foregoing detailed description has been presented for purposes of illustration and description. It is not intended to be exhaustive or limited to the precise form disclosed. Many modifications and variations are possible in light of the above teaching. The described embodiments were chosen in order to best explain the principles of the technology and its practical application, to thereby enable others skilled in the art to best utilize the technology in various embodiments and with various modifications as are suited to the particular use contemplated. It is intended that the scope of the technology be defined by the claims appended hereto.

What is claimed is:

1. A storage system, comprising:
a storage device; and
one or more processors executing code to manage the storage device, the one or more processors:
a. provides data to be stored in one or more files in the storage device, each file comprising a plurality of sectors of data;
b. without knowing a size of the one or more files, allocates at least two clusters in the storage device for storing the one or more files, wherein the at least two clusters are in a common partition of the storage device, and wherein a first one of the allocated clusters is allocated to a first portion of the storage device and contains a first number of sectors, a second one of the allocated clusters is allocated to a different, second portion of the storage device and contains a second number of sectors, and the first and second numbers of sectors are different from each other; and
c. stores the one or more files in the allocated clusters.

2. The storage system of claim 1, wherein:
the one or more processors maintain a file directory which identifies at least one file and a corresponding starting cluster which is allocated to the at least one file.

3. The storage system of claim 1, wherein:
the one or more processors maintain a file allocation table which links the clusters of at least one file.

4. The storage system of claim 1, wherein:
the one or more processors choose a suitable cluster size for writing at least one file based on whether the at least one file is to undergo compression before being stored on the storage device.

5. The storage system of claim 4, wherein:
the one or more processors allocate a smaller cluster size to the at least one file if it is to undergo compression before being stored on the storage device, and allocate a larger cluster size to the at least one file if it is not to undergo compression before being stored on the storage device.

6. The storage system of claim 1, wherein:
the one or more processors choose a suitable cluster size for writing at least one file based on an access pattern of a calling application which creates the at least one file.

7. The storage system of claim 1, wherein:
the one or more processors choose a suitable cluster size for writing at least one file based on a file type of the at least one file.

8. The storage system of claim 1, wherein:
the one or more processors choose a suitable cluster size for writing at least one file based on a file name extension of the at least one file.

9. The storage system of claim 1, wherein:
the one or more processors choose a suitable cluster size for writing at least one file based on an identity of a calling application which creates the at least one file.

10. The storage system of claim 1, wherein:
the storage device comprises flash memory.

11. A computer-implemented method for writing data to a storage device, comprising:
a. providing data to be stored in one or more files in the storage device, each file comprising a plurality of sectors of data;
b. without knowing a size of the one or more files, allocating at least two clusters in the storage device for storing the one or more files, wherein the at least two clusters are in a common partition of the storage device, and wherein a first one of the allocated clusters is allocated to a first portion of the storage device and contains a first number of sectors, a second one of the allocated clusters is allocated to a different, second portion of the storage device and contains a second number of sectors, and the first and second numbers of sectors are different from each other; and
c. storing the one or more files in the allocated clusters.

12. The computer-implemented method of claim 11, further comprising:
providing a file directory which identifies at least one file and a corresponding starting cluster which is allocated to the at least one file.

13. The computer-implemented method of claim 11, further comprising:
providing a file allocation table which links the clusters of at least one file.

14. The computer-implemented method of claim 11, further comprising:
choosing a suitable cluster size for at least one file based on whether the at least one file is to undergo compression before being stored on the storage device.

15. The computer-implemented method of claim 14, further comprising:
allocating a smaller cluster size to the at least one file if it is to undergo compression before being stored on the storage device, and allocating a larger cluster size to the at least one file if it is not to undergo compression before being stored on the storage device.

16. The computer-implemented method of claim 11, further comprising:
choosing a suitable cluster size for at least one file based on an access pattern of a calling application which creates the at least one file.

17. The computer-implemented method of claim 11, further comprising:
choosing a suitable cluster size for at least one file based on a file type of the at least one file.

18. The computer-implemented method of claim 11, further comprising:
choosing a suitable cluster size for at least one file based on an identity of a calling application which calls the file system to create the at least one file.

19. The computer-implemented method of claim 11, wherein:
the storage device comprises flash memory in a flash memory device, and the storing is responsive to a request which is received from a host device which is external to the flash memory device.
